(19) United States
(12) Patent Application Publication
(10) Pub. No.: US 2025/0284064 A1
(43) Pub. Date: Sep. 11, 2025

(54) FIBER OPTIC DISTRIBUTION ARCHITECTURE AND RELATED FIBER OPTIC COMPONENTS

(71) Applicant: CommScope Technologies LLC, Claremont, TX (US)

(72) Inventor: Thomas A. THIGPEN, Highland Village, TX (US)

(21) Appl. No.: 19/073,595

(22) Filed: Mar. 7, 2025

Related U.S. Application Data
(60) Provisional application No. 63/562,850, filed on Mar. 8, 2024.
(60) Provisional application No. 63/743,350, filed on Jan. 9, 2025.

(51) Int. Cl. G02B 6/28

(52) U.S. Cl. CPC G02B 6/2804

(57) ABSTRACT

The present disclosure relates to a fiber optic distribution architecture for an optical network that uses a relatively low fiber count cable and implements passive optical power splitting at or near an edge of the network. Optical components for building/deploying the architecture are also disclosed. The architectures can include pre-connectorized versions, spliced versions, and combinations thereof.

### CROSS-REFERENCE TO RELATED APPLICATION

The present application claims the benefit of U.S. Provisional Patent Application No. 63/562,850, filed Mar. 8, 2024, and U.S. Provisional Patent Application No. 63/743,350, filed Jan. 9, 2025, the disclosures of which are hereby incorporated by reference herein in their entirety.

### TECHNICAL FIELD

The present disclosure relates to fiber optic data transmission, and more particularly to fiber optic distribution systems and architectures.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. With regard to fiber optic communication systems, there is a need for distribution architectures that reduce cost particularly for rural deployments.

### SUMMARY

Aspects of the present disclosure relate to fiber optic distribution architectures that reduce cost and are easy to deploy. Certain aspects of the present disclosure relate to fiber optic architectures particularly well suited for deployment in lower density environments such as rural environments where subscribers are more spread out than urban environments. Certain aspects of the present disclosure relate to fiber optic architectures that move passive optical power splitting out toward the edge of the network (e.g., out to the “last mile”) and uses indexing and fiber optic connectors (e.g., hardened fiber optic connectors) to facilitate deployment in the field and to reduce field splicing.

One aspect of the present disclosure relates to a fiber distribution arrangement (e.g., a fiber distribution component) including a fiber optic cable including feed fibers and distribution fibers. The fiber optic cable includes a first end and an opposite second end. The fiber optic cable also includes an outer jacket within which the feed fibers and the distribution optical fibers are positioned. A first multi-fiber ferrule is adjacent the first end of the fiber optic cable and a second multi-fiber ferrule is adjacent the second end of the fiber optic cable. At least some of the feed fibers are indexing fibers that are routed in an indexing arrangement between the first and second multi-fiber ferrules. A drop optical fiber is coupled to the first multi-fiber ferrule. The arrangement also includes a passive optical power splitter having a splitter input and a plurality of splitter outputs. The drop optical fiber is optically coupled to the splitter input and first ends of the distribution fibers are optically coupled to the splitter outputs. Second ends of the distribution fibers are blunt ends positioned adjacent the second end of the fiber optic cable.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

FIG. 1 is a schematic view of an example fiber optic network deployment having a fiber optic distribution architecture in accordance with the principles of the present disclosure;

FIG. 2 is a more detailed schematic view of a portion (e.g., a fiber optic assembly forming a component that is a building-block for the architecture) of the deployment of FIG. 1;

FIG. 3 depicts an example terminal that can be included as part of the component of FIG. 2;

FIG. 4 is a schematic depicting example fiber routing within the terminal of FIG. 3;

FIG. 5 depicts an example end transition that can be utilized by the component of FIG. 2;

FIG. 6 depicts a transition and multi-fiber pigtail of the component of FIG. 2;

FIG. 7 depicts the transition and multi-fiber pigtail of FIG. 6 disposed in a pulling sock used for deployment of the component to build-out the architecture of FIG. 1;

FIG. 8 depicts a portion of another fiber optic network deployment in accordance with the principles of the present disclosure;

FIG. 9 is a more detailed schematic view of a portion (e.g., a fiber optic assembly forming a component that is a building-block for the architecture) of the deployment of FIG. 8;

FIG. 10 depicts an example distribution terminal adapted for use with the deployment of FIG. 8;

FIG. 11 depicts a portion of a further fiber optic network deployment in accordance with the principles of the present disclosure;

FIG. 12 is a more detailed schematic view of a portion (e.g., a fiber optic assembly forming a component that is a building-block for the architecture) of the deployment of FIG. 11; and

FIG. 13 depicts an example splitter terminal adapted for use with the deployment of FIG. 11.

### DETAILED DESCRIPTION

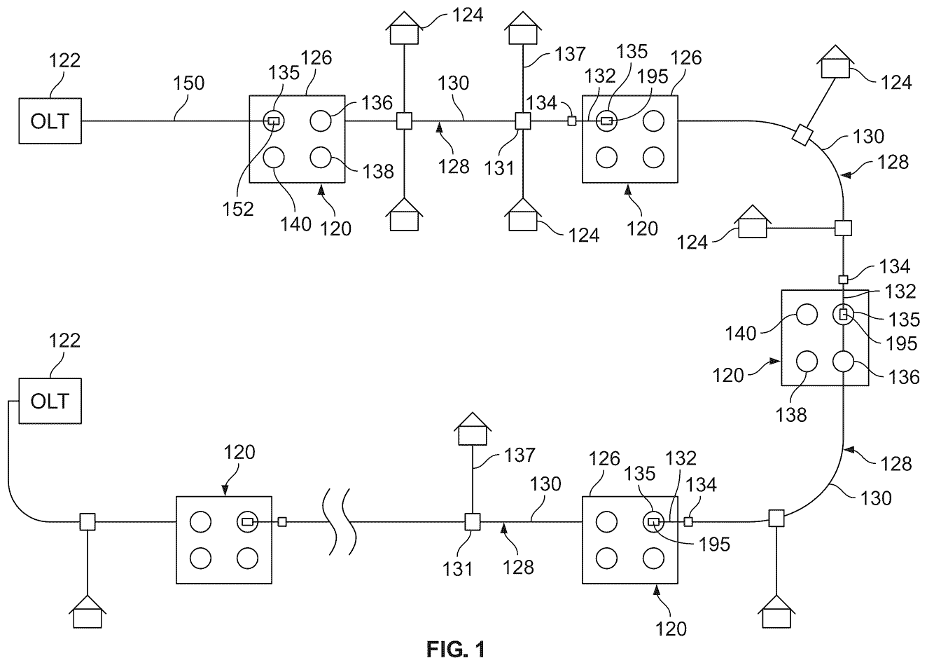

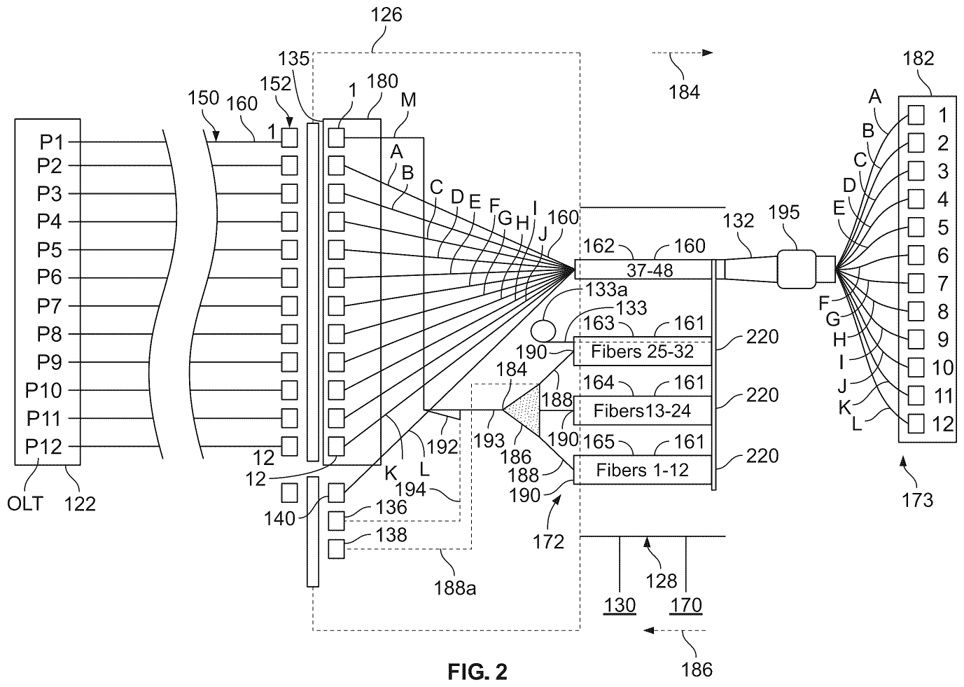

FIG. 1 is a schematic view of an example fiber optic network deployment having a fiber optic distribution architecture in accordance with the principles of the present disclosure. The fiber optic architecture includes a plurality of fiber optic components 120 each being a fiber distribution arrangement (e.g., an arrangement of fiber optic structures which may include structures such as optical fibers, a passive optical splitter or splitters, a terminal or terminals, a cable or cables, a fiber optic connector or connectors, a fiber optic connection port or ports, etc.). The fiber optic components 120 are chained together in series (e.g., daisy-chained) to build-out the fiber distribution architecture. The fiber optic architecture is adapted for distributing optical communication between a signal feed structure such an optical line terminal 122 (OLT) to subscriber locations 124. Feed structures (e.g., one OLT or separate OLT's) can be connected at opposite ends of the architecture to provide signal feeds in both forward and reverse directions through the architecture. The fiber optic components 120 can each include a terminal 126 and a fiber optic cable 128 that extends from the terminal 126. In one example, the fiber optic cable 128 can be a stub cable (e.g., a tether) having a base end that is routed into, sealed and secured with respect to the terminal 126. In one example, the fiber optic cable 128 has a length of at least 1000 feet; or at least 2000 feet; or at least 3000 feet; or at least 4000 feet; or in the range of 1000-5000 feet. In one example, the fiber optic cable 128 includes a main cable portion 130, a connectorized multi-fiber pigtail 132 at an end of the fiber optic cable 128 opposite from the terminal 126 and a transition 134 between the main cable portion 130 and the connectorized multi-fiber pigtail 132. Feed fibers are routed through the main cable portion 130 and the connectorized multi-fiber pigtail 132. Distribution fibers are routed only through the main cable portion 130 and not the multi-fiber pigtail 132. Optical connectivity (e.g., optical signals) is fed to the architecture from the feed structure or structures (e.g., OLT 122) through the feed fibers and is distributed to the distribution fibers of each component 120 at the terminals 126. Preferably, a fiber indexing configuration is used for the feed fibers to facilitate connecting the appropriate ports of the OLT 122 to the appropriate distribution fibers at each fiber optic component 120 in the chain of fiber optic components 120. As shown at FIGS. 1 and 2, the terminals 128 can include outside accessible hardened connector ports adapted for coupling with hardened fiber optic connectors (e.g., feed fiber ports 135, monitor ports 136; drop ports 138 for connecting with split signals; and drop ports 140 for connecting with un-split (e.g., point-to-point) signals).

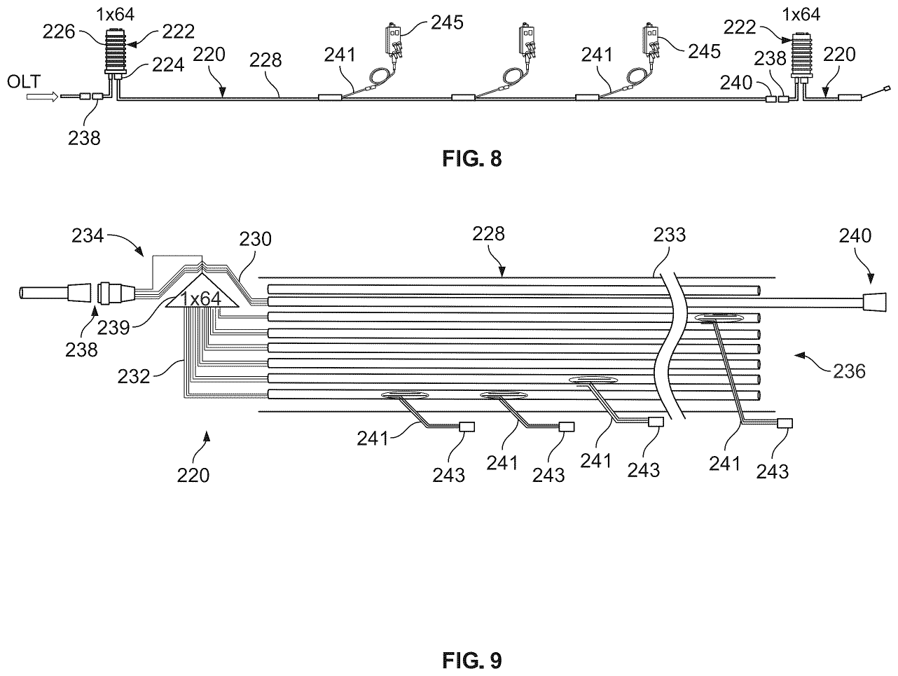

In certain examples, the number of components 120 that can be chained together corresponds to the number of feed fibers provided (e.g., twelve components 120 can be chained together when using an architecture with twelve fiber ferrules at the multi-fiber pigtails 132). To connect the subscribers 124 to the network architecture, the distribution fibers can be accessed through the main portions 130 of the cables 128 and connected (e.g., optically spliced) to drop fibers 137 (e.g., drop cables) routed to the subscriber locations 124. It will be appreciated that the distribution fibers can be accessed by cutting into or otherwise opening the main portions 130 of the cables 128 in the field to form access locations near the subscriber locations 124. Housings or other closures 131 can be used to close and seal the access locations in the main portions 130 of the cables 128 after connection of the subscribers. In other examples, break-outs (e.g., sealed tethers/stubs) can be integrated into the cable. In certain examples, as shown at FIGS. 8 and 9, the break-outs can be integrated (e.g., factory integrated; factory installed, etc.) at pre-determined locations along the main cable portions. In certain examples, the break-outs can be fiber optic tethers/stubs terminated with fiber optic connectors (e.g., hardened or non-hardened fiber optic connectors that can include single fiber or multi-fiber connectors). In the field, the break-outs can couple to distribution terminals that can include break-out terminals or splitter terminals. The distribution terminals can include ports (e.g., hardened ports such as ports including hardened fiber optic adapters) adapted to couple to drop cables routed to subscriber locations.

FIG. 2 is a more detailed schematic view of a first one of the fiber optic components 120 of the architecture of FIG. 1. FIG. 2 also depicts the optical line terminal 122 which is connected to the chain of fiber optic components 120 by a multi-fiber cable 150 (e.g., a twelve-fiber cable). The multi-fiber cable 150 can be terminated by a hardened multi-fiber connector 152 that plugs into the feed fiber port 135 of the first fiber optic component 120 in the chain of fiber optic components 120. The optical line terminal 122 is shown having twelve ports labeled ports P1-P12. The architecture preferably has an indexing arrangement configured for indexing the feed fibers such that when the architecture is deployed: the first port P1 is connected to the distribution fibers of the first fiber optic component 120 in the chain; the second port P2 is connected to the distribution fibers of the second fiber optic component 120 in the chain; the third port P3 is connected to the distribution fibers of the third fiber optic component 120 in the chain; the fourth port P4 is connected to the distribution fibers of the fourth fiber optic component 120 in the chain; the fifth port P5 is connected to the distribution fibers of the fifth fiber optic component 120 in the chain; the sixth port P6 is connected to the distribution fibers of the sixth fiber optic component 120 in the chain; the seventh port P7 is connected to the distribution fibers of the seventh fiber optic component 120 in the chain; the eighth port P8 is connected to the distribution fibers of the eighth fiber optic component 120 in the chain; the ninth port P9 is connected to the distribution fibers of the ninth fiber optic component 120 in the chain; the tenth port P10 is connected to the distribution fibers of the tenth fiber optic component 120 in the chain; the eleventh port P11 is connected to the distribution fibers of the eleventh fiber optic component 120 in the chain; and the twelfth port P12 is connected to the distribution fibers of the twelfth fiber optic component 120 in the chain.

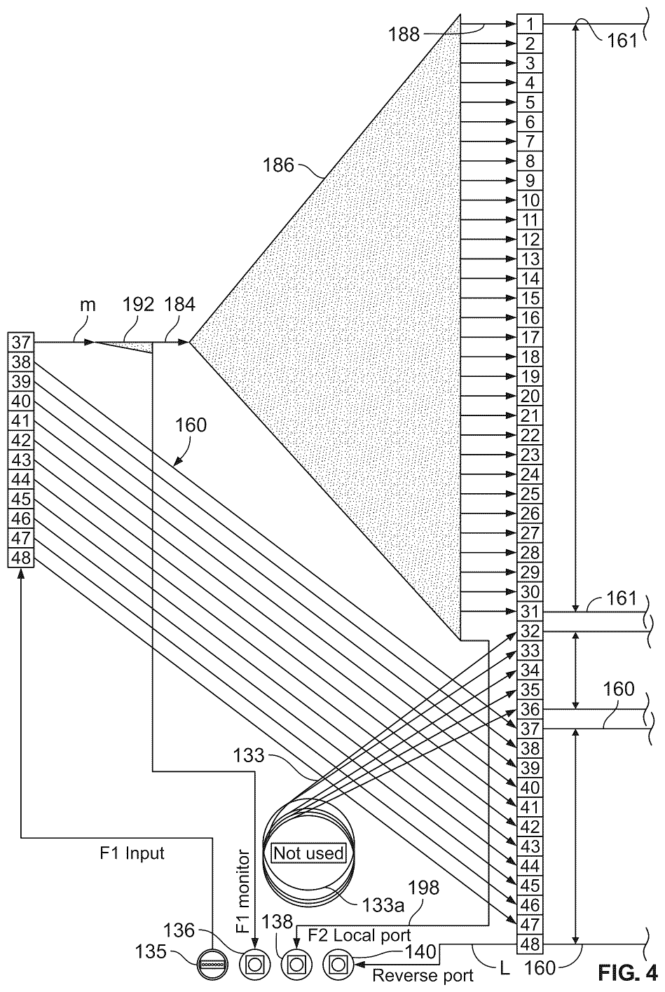

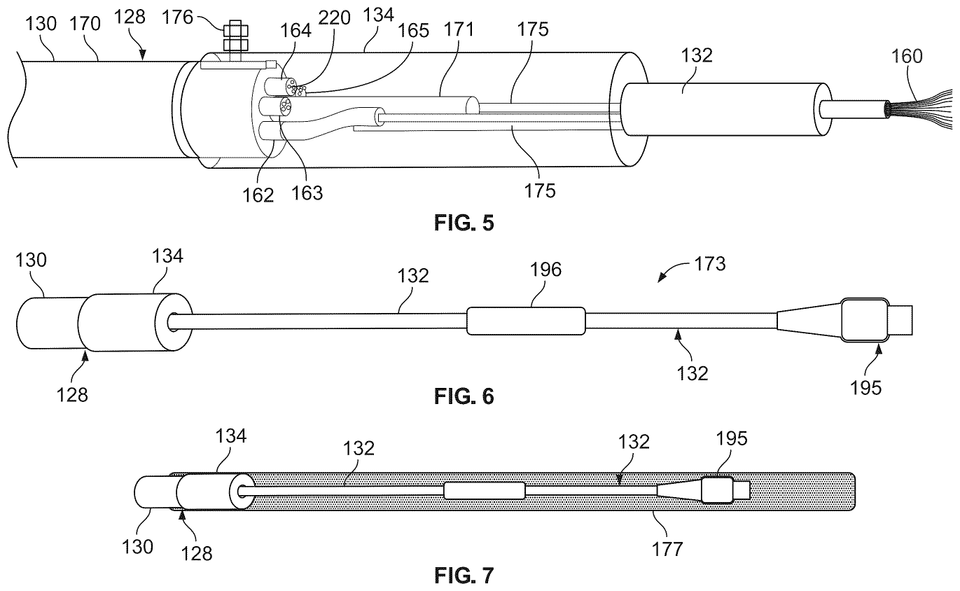

Referring still to FIG. 2, the fiber optic component 120 includes the fiber optic cable 128 which includes optical fibers including feed fibers 160 and distribution fibers 161. Buffer tubes can be provided in the cable 128 to separate the optical fibers into different groups. As depicted, the feed fibers 160 can be positioned within a first buffer tube 162 and the distribution fibers can be divided between a second buffer tube 163, a third buffer tube 164 and fourth buffer tube 165. The distribution fibers 161 extend through the main cable portion 130; but do not extend through the multi-fiber connectorized pigtail 132. Instead, the distribution fibers 161 terminate at the transition 134 (see FIG. 5). In certain examples, the fiber optic cable includes thirty-six to sixty optical fibers or at least forty-eight optical fibers. As depicted, the fiber optic cable 128 includes forty-eight optical fibers with twelve fibers in each of the buffer tube. Some of the optical fibers (e.g., some of the distribution optical fibers) can be dark fibers 133 (see FIG. 4) and available for later use (e.g., expansion or repair). The dark fibers can include stored end portions 133a that are stored (e.g., coiled) within the terminal and available for later access and use. As shown at FIG. 4, fibers 32-36 are dark; fibers 1-31 are distribution fibers and fibers 37-48 are feed fibers.

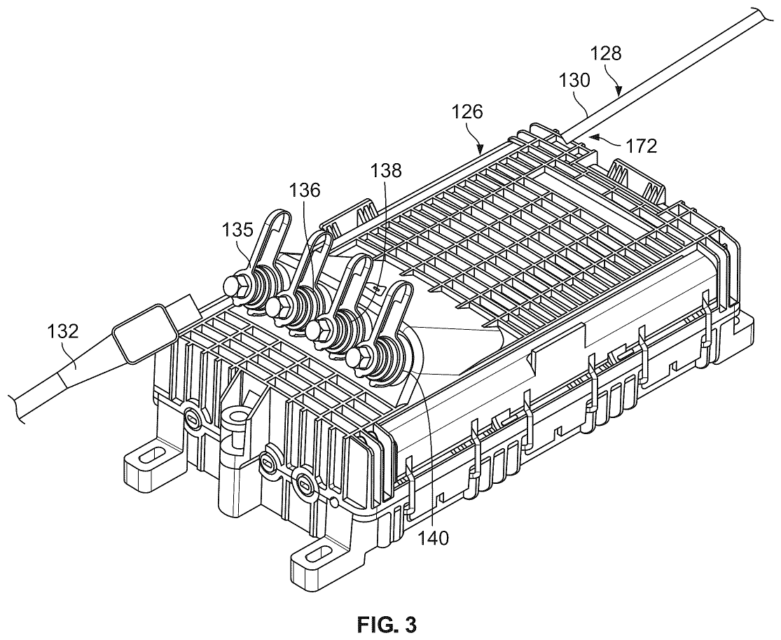

The fiber optic cable 128 can include an outer jacket 170 and at least one strength member 171 (e.g., a fiberglass reinforced polymer rod; which as depicted at FIG. 5 is central strength member about which the buffer tubes 162-165 are positioned). The outer jacket 170 can contain the optical fibers, the buffer tubes and the strength member. The fiber optic cable 128 has a first end 172 (sec FIGS. 2 and 3) and an opposite second end 173 (see FIG. 6). The first end 172 is located at the terminal 126 and the multi-fiber connectorized pigtail 132 is positioned at the second end 173. As depicted, the distribution fibers 161 have blunt ends 220 adjacent the second end 173 of the fiber optic cable 128. Blunt ends 220 are ends that do not make optical connections and/or through which optical signals do not pass through to other structures; but instead form dead ends at which the fibers 161 terminate. The transition 134 is positioned adjacent the second end 173 of the cable 128 and include a volume (e.g., block, portion, extension, etc.) of curable polymeric material such as adhesive that can be overlaid by a sleeve such as a shape memory (e.g., heat shrink) sleeve. The strength member 171, the buffer tubes 162-165 and the distribution fibers 161 can have ends that terminate and are anchored in the transition 134 (e.g., in the volume of adhesive of the transition 134). The feed fibers 160 pass through the transition 134 to the corresponding multi-fiber connectorized pigtail 132. The multi-fiber connectorized pigtail 132 can include an outer jacket (e.g., an up-jacket) that extends from the transition 134 and contains the feed fibers 160 as well as at least one strength member 175. The strength member 175 can have an end anchored to the transition 34 (e.g., within the adhesive of the transition). A shield bond 176 for armored cable (e.g., for grounding a shield of an armored cable) can be provided at the transition 134. As shown at FIG. 7, a pulling device such as a pulling sock 177 can be attached to the transition 134 and can cover the multi-fiber connectorized pigtail 132. The pulling sock 177 can be used to pull the cable 128 along a routing path during installation of the component 120 and can be removed from the multi-fiber connectorized pigtail 132 after installation to expose the connectorized end of the multi-fiber connectorized pigtail 132.

The fiber optic component 120 includes a first multi-fiber ferrule 180 (e.g., an MPO ferrule) adjacent the first end 172 of the fiber optic cable 128 and a second multi-fiber ferrule 182 (e.g., an MPO ferrule) adjacent the second end 173 of the fiber optic cable 128. The first and second multi-fiber ferrules 180, 182 each define fiber securement positions arranged in a sequence such as in a row. As depicted, the sequence includes twelve fiber securement positions numbered 1-12 which are arranged consecutively in a row. The fiber securement positions of the sequence include a drop position. For example, in a forward signal direction 184, position 1 is a drop position (e.g., see position 1 of the first multi-fiber ferrule 180) for the feed fibers 160. In a reverse signal direction 186, position 12 is a drop position (e.g., see position 12 of the second multi-fiber ferrule 182) for the feed fibers 160. At least some of the feed fibers 160 are indexing fibers having first fiber ends secured at the fiber securement positions of the first multi-fiber ferrule 180 and second fiber ends secured at the fiber securement positions of the second multi-fiber ferrule 182. As depicted at FIG. 2, the second fiber ends at the second multi-fiber ferrule 182 are shifted with respect to the first fiber ends at the first multi-fiber ferule 180 in a direction toward the drop position (e.g., position 1 at the second multi-fiber ferrule 182) the with one of the second ends being secured at the drop position. For example, as shown at FIG. 2, optical fibers A-K are indexing fibers with first ends of the fibers A-K respectively secured at positions 2-12 of the first multi-fiber ferrule 180 and with second ends of the fibers A-K respectively secured at positions 1-11 of the second multi-fiber ferrule 182. Position 12 of the second multi-fiber ferrule 182 corresponds to a drop position for the reverse feed signal direction 186 and position 1 of the first multi-fiber ferrule 180 corresponds to a drop position for the forward feed signal direction 184.

A drop optical fiber M has one end secured at the drop position (e.g., position 1) of the first multi-fiber ferrule 180 and a drop optical fiber L has one end secured at the drop position (e.g., position 12) of the second multi-fiber ferrule 182. The drop optical fiber M optically connects to a splitter input 184 of passive optical splitter 186. As depicted, the passive optical splitter 186 has a split ratio of 1×32; but other split ratios such as 1×8; 1×16 and 1×64 can also be used. In one example, the passive optical splitter 186 has a split ratio of at least 1×32. The passive optical power splitter 186 includes splitter outputs 188 that optically connect to active ends 190 of the distribution fibers 161 such that split feed fiber signals can be directed in the forward feed direction 184 through the distribution fibers 161. The distribution fibers 161 carrying the split feed signals can be accessed along the length of the main portion 130 of the fiber optic cable 128 to provide drop connections to subscriber locations (e.g., via optically splicing selected ones of the distribution fibers 161 to drop fibers of drop cables 137 routed to the subscriber locations). The drop optical fiber L is shown optically connecting to the reverse feed port 140 of the terminal 126. In one example, a feed signal transmitted in the reverse direction 186 can be accessed at the reverse feed port 140. Such a signal can be unsplit to provide point-to-point optical connection capability.

In one example the drop optical fiber M connects to an input of an optical tap 192. A major output 193 of the optical tap 92 optically connects to the splitter input 184 of the passive optical power splitter 186 such that the drop fiber M optically couples to the splitter input 184 through the optical tap 192. A minor output 194 of the optical tap 192 optically connects to the monitor port 136 of the terminal 126. In other examples, the optical tap 192 can be eliminated and the drop optical fiber M can connect directly to the splitter input 184.

In one example, one or more of the splitter outputs 188 (e.g., see output 188a) can optionally be optically connected to one or more drop ports 138 of the terminal 126 to provide the ability to connect a subscriber or subscribers to split signals of the network by a connectorized connection or connections at the terminal 126. It will be appreciated that this reduces the number of splitter outputs 188 available for connection to the distribution fibers 161 of the cable 128; but provides hardened connectivity access to subscribers directly from the terminal 126.

The second multi-fiber ferrule 182 can be part of a multi-fiber connector 195 mounted at an end of the multi-fiber pigtail 132 that extends outwardly from the transition 134. It is preferred for the multi-fiber connector 195 to be a hardened multi-fiber connector. In one example, the multi-fiber connector 195 is a splice-on connector having a multi-fiber splice location 196 at an intermediate location along the multi-fiber pigtail 132. As depicted, the first multi-fiber ferrule 180 is provided at the hardened feed port 135 of the terminal 126. In certain examples, the hardened feed port 135 can be a hardened fiber optic adapter coupled to a wall of the terminal 126 or a hardened multi-fiber plug/jack mounted at the end of a stub/tether that extends outwardly from the terminal 126. In other examples, the multi-fiber ferrule 180 can be included as part of a non-hardened multi-fiber connector (e.g., an MPO connector having an MPO ferrule) that is protected within the terminal 126.

FIGS. 8 and 9 depict another fiber optic deployment having fiber optic components 220 in accordance with the principles of the present disclosure that can be daisy-chained together to extend the network architecture. One of the fiber optic components 220 is depicted schematically at FIG. 9. The fiber optic components 220 can be used in combination with enclosures such as dome-style closures 222. The dome-style closures can each include a base 224 defining a plurality of scalable cable pass-through ports, and a dome 226 that mounts on the base 224.

The fiber optic component 220 includes a fiber optic cable 228 having feed fibers 230 and distribution fibers 232. The fiber optic cable 228 includes a first end 234 and an opposite second end 236. Similar to the main cable portion 130 described above, the fiber optic cable 228 can include buffer tubes for organizing the feed fibers 230 and the distribution fibers 232, and a protective outer cable jacket 233 surrounding the buffer tubes and the optical fibers. The cable 220 can additionally include one or more strength elements.

The fiber optic component 220 includes a first multi-fiber connection location 238 adjacent the first end 234 of the cable 228 and a second multi-fiber connection location 240 adjacent the second end 236 of the cable 228. It will be appreciated that the feed fibers 230 can be indexed between the first multi-fiber connection location 238 and the second multi-fiber connection location 240 in the same manner described above with respect to the fiber optic component 120. In one example, the first multi-fiber connection location 238 can include a hardened fiber optic connector such as a hardened fiber optic jack and the second multi-fiber connection location can include a hardened fiber optic connector such as a hardened fiber optic plug. The hardened fiber optic jack and the hardened fiber optic plug can be configured to be mateable with respect to one another. In this way, a plurality of the fiber optic components 220 can be daisy-chained together. In such a configuration, the hardened fiber optic jack of a given one of the fiber optic components 220 can be configured to optically couple with the hardened fiber optic plug of an upstream fiber optic component 220 and the hardened fiber optic plug of the given fiber optic component 220 can be configured to optically couple with the hardened fiber optic jack of a downstream fiber optic component 220. It will be appreciated that the hardened fiber optic jack can include a multi-fiber ferrule such as the multi-fiber ferrule 180 and the hardened fiber optic plug can include a multi-fiber ferrule such as the ferrule 182. The fiber optic component 220 can include a similar or the same fiber indexing configuration, fiber drop configuration and optical splitting configuration as the fiber optic component 120 of FIG. 2. In the depicted example, splitting of a signal from a dropped optical fiber is provided by a passive optical splitter 239 such as a 1×64 passive optical power splitter. It will be appreciated that other split ratios could also be used such as 1×16 or 1×32. In an alternative example, rather than using hardened connectors at the first and second multi-fiber connection locations 238, 240, non-hardened connectors such as non-hardened multi-fiber connectors (e.g., MPO connectors) can be used. Such non-hardened fiber optic connectors can be coupled together with the assistance of non-hardened fiber optic adapters with the non-hardened fiber optic connectors and the non-hardened fiber optic adapters being protected within enclosures such as the enclosures 222. In still other examples, the first and second multi-fiber connection locations 238, 240 can be configured to facilitate optical splicing between the fiber optic components 220. For example, the optical fibers at the first and second ends 234, 236 can be ribbonized to facilitate mass fusion splicing. It will be appreciated that by ribbonizing the optical fibers, the optical fibers can be maintained in a particular order or sequence to facilitate indexing.

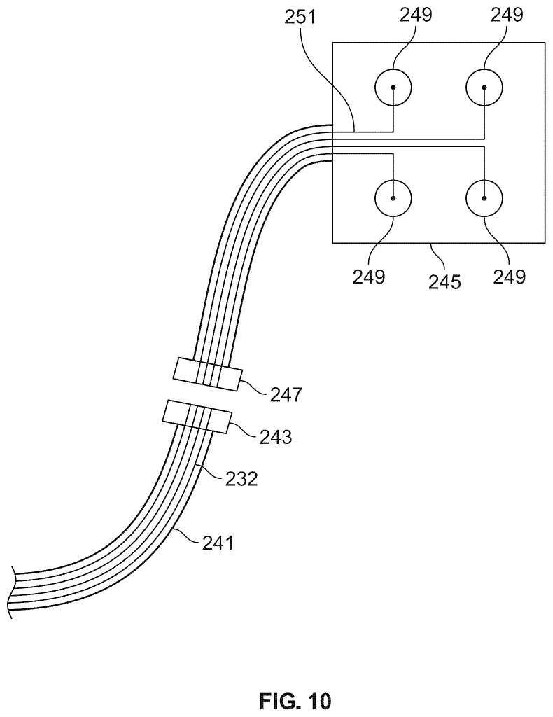

In the depicted example of FIGS. 8 and 9, the fiber optic cable 228 has mid-span break-out locations integrated into the cable at predetermined locations along the length of the cable 228. In certain examples, the break-out locations are factory integrated into the cable 228 as part of the cable manufacturing process. The break-out locations provide optical access to the distribution fibers 232 to facilitate connecting the distribution fibers to subscriber locations via drop cables. The break-out locations can each include one or more tethers 241 each having one or more optical fibers with each optical fiber optically coupled to one of the distribution fibers 232. The tethers 241 can have free ends terminated by fiber optic connectors such as multi-fiber connectors or single-fiber connectors. The fiber optic connectors can be hardened or non-hardened. In the depicted example of FIGS. 9 and 10, each of the tethers 241 includes a plurality of optical fibers (e.g., four optical fibers) and each of the tethers 241 has a free end terminated by a hardened multi-fiber optical connector 243. In the field, the free ends of the tethers 241 can be coupled to distribution terminals 245 (sec FIGS. 8 and 10). The distribution terminals 245 can include hardened multi-fiber connectors 247 adapted to be connected to the hardened multi-fiber optical connectors 243, and can also include optical ports 249 (e.g., hardened optical ports such as ports including hardened fiber optic adapters) adapted for connection to drop cables that can be routed to subscriber locations. The drop cables can have ends terminated with hardened fiber optic connectors that are plugged into the optical ports 249. In the depicted example, the optical ports 249 are single-fiber optical ports. Optical fibers 251 (e.g., for optical fibers) are routed from the optical ports 249 to the multi-fiber connector 247 such that when the hardened multi-fiber connectors 247 are optically coupled with the hardened multi-fiber optical connectors 243 of the tethers 241, the distribution fibers 232 are connected to the optical ports 249.

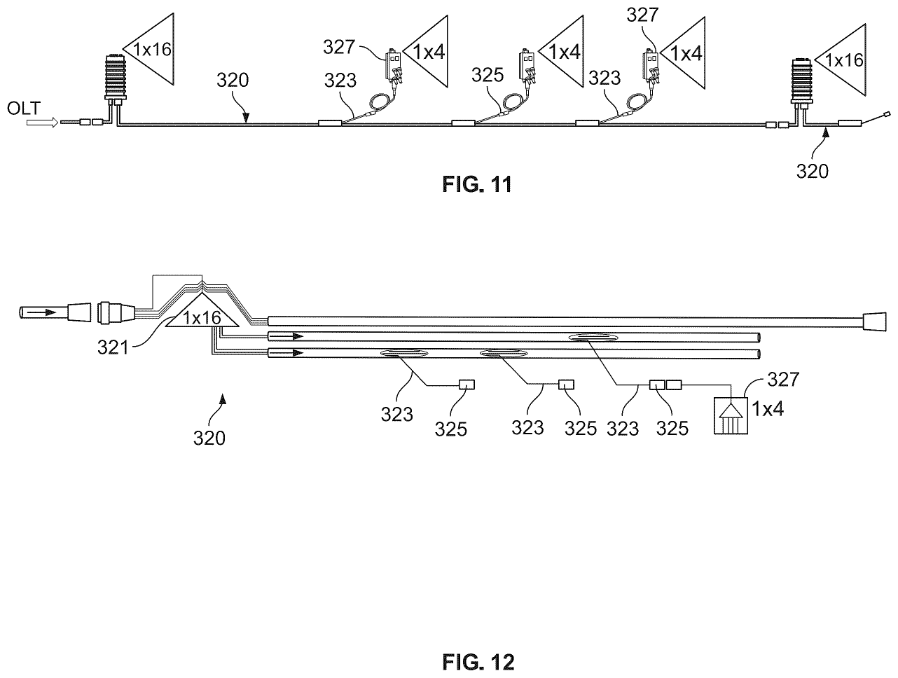

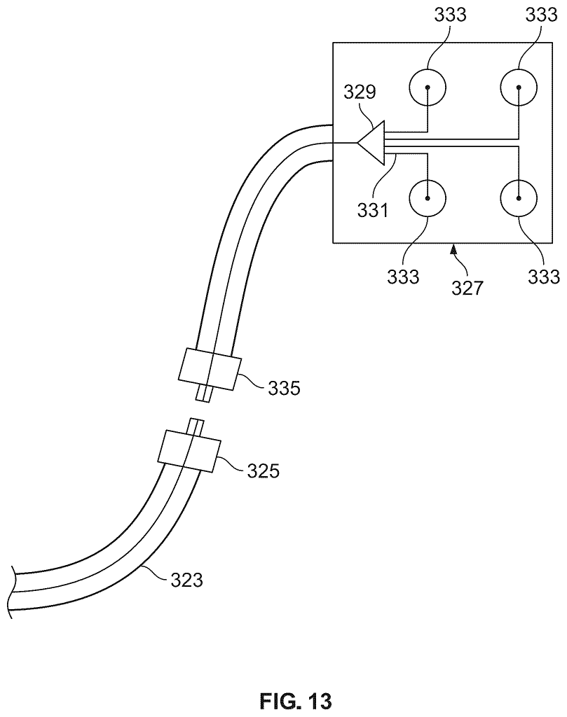

FIGS. 11-13 depict another fiber optic deployment having fiber optic components 320 in accordance with the principles of the present disclosure that can be daisy-chained together to extend the network architecture. One of the fiber optic components 320 is depicted schematically at FIG. 12. The fiber optic components 320 have the same general construction as the fiber optic components 220 except the fiber optic components 320 are adapted to support an architecture where at least some passive optical power splitting is moved farther out toward the edge of the network closer to the subscriber locations. This architecture provides a more distributed split configuration. The fiber optic components 320 have passive optical splitters 321 (which can be housed within enclosures such as enclosures 222 between which lengths of distribution cable are routed) having a reduced split ratio as compared to the passive optical splitters 239. The passive optical splitters 321 can have inputs that receive signals from dropped optical feed fibers and outputs optically connected to distribution fibers of the distribution cables. The fiber optic components 320 can include mid-span break-outs spaced along the distribution cables. The break-outs can include tethers 323 having free ends terminated by fiber optic connectors 325. In the depicted example, each of the tethers 323 has a single fiber connected to one of the distribution fibers and the fiber optic connectors 325 are single-fiber optical connectors such as single-fiber hardened fiber optic connectors. In the field, the tethers 323 can be connected to splitter terminals 327. The splitter terminals 327 include passive optical splitters 329 having outputs 331 connected to optical ports 333 adapted for connection to drop cables routed to subscriber locations. The splitter terminals 327 can include single-fiber optical connectors 335 adapted for connection with respect to the fiber optic connectors 325. In this way, each of the distribution fibers accessed at one of the tethers 323 can be optically connected to the input of the splitter of the corresponding splitter terminal. The outputs of the splitter within the terminal are optically connected to the optical ports 333 such that the distribution fibers are also optically connected to the optical ports 333.

It will be appreciated that factory integrated break-outs in combination with break-out terminals (as shown at FIGS. 8-10) and factory terminated break-outs in combination with a more distributed split configuration including splitter terminals (as shown at FIGS. 11-13) can also be incorporated in architectures and components having bidirectional splitter outputs as disclosed by the embodiment of FIG. 2 and other embodiments of U.S. patent application Ser. No. 18/964,027 which is hereby incorporated by reference in its entirety.

Example hardened (e.g., ruggedized) and non-hardened demateable connectorized optical connection interfaces including single fiber optic adapters and fiber optic connectors are disclosed by U.S. Pat. No. 7,744,288 which is hereby incorporated by reference in its entirety. Example hardened (e.g., ruggedized) and non-hardened demateable connectorized optical connection interfaces including multi-fiber optic adapters and fiber optic connectors are disclosed by U.S. Pat. Nos. 9,442,257; 7,264,402 and 7,137,742 which are hereby incorporated by reference in their entireties. Example indexing patterns and systems using hardened multi-fiber connectors are disclosed by U.S. Pat. No. 10,788,629 which is hereby incorporated by reference in its entirety.

Example hardened fiber optic connectors can be adapted for outdoor environmental use. Example hardened fiber optic connectors can be environmentally sealed when mated with a corresponding hardened component such as another hardened connector or a hardened port. Example hardened fiber optic connectors can be adapted to withstand a pull-out force of at least 25 pounds or at least 50 pounds when mated with a corresponding hardened component.

From the foregoing detailed description, it will be evident that modifications and variations can be made in the devices of the disclosure without departing from the spirit or scope of the invention.

What is claimed is:

1. A fiber distribution arrangement comprising:
a fiber optic cable including optical fibers which include feed fibers and distribution fibers, the fiber optic cable including a first end and an opposite second end, the fiber optic cable including an outer jacket within which the optical fibers are positioned;
a first multi-fiber ferrule adjacent the first end of the fiber optic cable and a second multi-fiber ferrule adjacent the second end of the fiber optic cable, the first and second multi-fiber ferrules each defining fiber securement positions arranged in a sequence, the fiber securement positions of the sequence including a drop position;
at least some of the feed fibers being indexing fibers having first fiber ends secured at the fiber securement positions of the first multi-fiber ferrule and second fiber ends secured at the fiber securement positions of the second multi-fiber ferrule, wherein the second fiber ends are shifted with respect to the first fiber ends in a direction toward the drop position with one of the second ends being secured at the drop position;
a drop optical fiber secured at the drop position of the first multi-fiber ferrule;
a passive optical power splitter having a splitter input and a plurality of splitter outputs, wherein the drop optical fiber is optically coupled to the splitter input and wherein first ends of the distribution fibers are optically coupled to the splitter outputs;
wherein second ends of the distribution fibers are blunt ends positioned adjacent the second end of the fiber optic cable.

2. The fiber distribution arrangement of claim 1, wherein the blunt ends are positioned at a transition component adjacent the second end of the fiber optic cable, and wherein the second multi-fiber ferrule is part of a multi-fiber connector mounted at an end of a fiber optic pigtail that extends outwardly from the transition component.

3. The fiber distribution arrangement of claim 2, wherein the transition component is filled with an adhesive material.

4. The fiber distribution arrangement of claim 2, wherein the multi-fiber connector is a hardened multi-fiber connector.

5. The fiber distribution arrangement of claim 1, further comprising a terminal positioned adjacent the first end of the fiber optic cable, wherein the fiber optic cable is routed into the terminal, wherein the passive optical splitter is positioned within the terminal, and wherein the first multi-fiber ferrule is provided at a hardened port of the terminal.

6. The fiber distribution arrangement of claim 5, wherein the drop optical fiber connects to an input of an optical tap, wherein a major output of the optical tap optically connects to the splitter input, and wherein a minor output of the optical tap optically connects to a monitor port of the terminal.

7. The fiber distribution arrangement of claim 5, wherein the drop optical fiber is a first drop optical fiber, and wherein a second drop optical fiber is optically coupled between a drop port of the terminal and one of the fiber securement positions of the second multi-fiber ferrule.

8. The fiber distribution arrangement of claim 1, wherein the passive optical power splitter is a 1 by 32 splitter.

9. The fiber distribution arrangement of claim 1, wherein the passive optical power splitter has a split ratio of at least 1 by 32.

10. The fiber distribution arrangement of claim 1, wherein the fiber optic cable includes 36-60 optical fibers.

11. The fiber distribution arrangement of claim 1, wherein the fiber optic cable includes 48 optical fibers.

12. A fiber distribution arrangement comprising:
a fiber optic cable including feed fibers and distribution fibers, the fiber optic cable including a first end and an opposite second end, the fiber optic cable including an outer jacket within which the feed fibers and the distribution optical fibers are positioned;
a first multi-fiber ferrule adjacent the first end of the fiber optic cable and a second multi-fiber ferrule adjacent the second end of the fiber optic cable;
at least some of the feed fibers being indexing fibers that are routed in an indexing arrangement between the first and second multi-fiber ferrules;
a drop optical fiber coupled to the first multi-fiber ferrule;
a passive optical power splitter having a splitter input and a plurality of splitter outputs, wherein the drop optical fiber is optically coupled to the splitter input and wherein first ends of the distribution fibers are optically coupled to the splitter outputs;
wherein second ends of the distribution fibers are blunt ends positioned adjacent the second end of the fiber optic cable.

13. The fiber distribution arrangement of claim 12, wherein the dead ends are positioned at a transition component adjacent the second end of the fiber optic cable, and wherein the second multi-fiber ferrule is part of a multi-fiber connector mounted at an end of a fiber optic pigtail that extends outwardly from the transition component.

14. The fiber distribution arrangement of claim 13, wherein the transition component is filled with an adhesive material.

15. The fiber distribution arrangement of claim 13, wherein the multi-fiber connector is a hardened multi-fiber connector.

16. The fiber distribution arrangement of claim 1, further comprising a terminal positioned adjacent the first end of the fiber optic cable, wherein the fiber optic cable is routed into the terminal, wherein the passive optical splitter is positioned within the terminal, and wherein the first multi-fiber ferrule is provided at a hardened port of the terminal.

17. The fiber distribution arrangement of claim 16, wherein the drop optical fiber connects to an input of an optical tap, wherein a major output of the optical tap optically connects to the splitter input, and wherein a minor output of the optical tap optically connects to a monitor port of the terminal.

18. The fiber distribution arrangement of claim 16, wherein the drop optical fiber is a first drop optical fiber, and wherein a second drop optical fiber is optically coupled between a drop port of the terminal and one of the fiber securement positions of the second multi-fiber ferrule.

19. The fiber distribution arrangement of claim 12, wherein the passive optical power splitter is a 1 by 32 splitter.

20. The fiber distribution arrangement of claim 12, wherein the passive optical power splitter has a split ratio of at least 1 by 32.

21. The fiber distribution arrangement of claim 12, wherein the fiber optic cable includes 36-60 optical fibers.

22. The fiber distribution arrangement of claim 12, wherein the fiber optic cable includes 48 optical fibers.

23. The fiber distribution arrangement of claim 12, wherein the feed fibers are in a first buffer tube of the fiber optic cable and the distribution fibers are in a plurality of second buffer tubes of the fiber optic cable.

24. A fiber distribution arrangement comprising:
a fiber optic cable including feed fibers and distribution fibers, the fiber optic cable including a first end and an opposite second end, the fiber optic cable including an outer jacket within which the feed fibers and the distribution optical fibers are positioned;
a first multi-fiber connection location adjacent the first end of the fiber optic cable and a second multi-fiber connection location adjacent the second end of the fiber optic cable;
at least some of the feed fibers being indexing fibers that are routed in an indexing arrangement between the first and second multi-fiber connection locations;
a drop optical fiber coupled to the first multi-fiber connection location;
a passive optical power splitter having a splitter input and a plurality of splitter outputs, wherein the drop optical fiber is optically coupled to the splitter input and wherein first ends of the distribution fibers are optically coupled to the splitter outputs;
wherein second ends of the distribution fibers are blunt ends positioned adjacent the second end of the fiber optic cable.

25. The fiber distribution arrangement of claim 24, wherein the first and second multi-fiber connection locations each include a multi-fiber ferrule.

26. The fiber distribution arrangement of claim 25, wherein the multi-fiber ferrules are included as part of hardened fiber optic connectors.

27. The fiber distribution arrangement of claim 24, wherein the first and second multi-fiber connection locations are adapted to facilitate optical fusion splicing.

28. The fiber distribution arrangement of claim 24, wherein the first and second multi-fiber connection locations are ribbonized.

29. The fiber distribution arrangement of claim 24, further comprising subscriber access locations spaced along the fiber optic cable for accessing the distribution fibers.

30. The fiber distribution arrangement of claim 29, wherein the subscriber access locations include factory integrated break-outs.

31. The fiber distribution arrangement of claim 30, further comprising break-out terminals adapted to be connected to the distribution fibers in the field at the factory integrated break-outs.

32. The fiber distribution arrangement of claim 30. further comprising splitter terminals adapted to be connected to the distribution fibers in the field at the factory integrated break-outs.
